(19) United States
(12) Patent Application Publication
(10) Pub. No.: US 2026/0208504 A1
(43) Pub. Date: Jul. 23, 2026

(54) DRYING UNIT FOR DRYING A SUBSTRATE

(71) Applicant: BOBST ITALIA S.P.A., Piacenza (IT)

(72) Inventors: Andrea PATRUCCO, Casale Monferrato (IT); Davide PARODI, Asti (IT)

(73) Assignee: BOBST ITALIA S.P.A., Piacenza (IT)

(21) Appl. No.: 19/137,441

(22) PCT Filed: Dec. 12, 2023
(86) PCT No.: PCT/EP2023/085416

§ 371 Date: Jun. 10, 2025

(30) Foreign Application Priority Data
Dec. 20, 2022 (EP) 22215012.0

(51) Int. Cl. B41J 11/00; F26B 3/04; F26B 13/10; F26B 21/37

(52) U.S. Cl. CPC B41J 11/00222; F26B 3/04; F26B 13/103; F26B 21/37

(57) ABSTRACT

The invention is about a drying unit for a digital printing machine. The drying unit is made of an alternation of impingement nozzles and flotation nozzles connected to a common pressurized air source. The impingement nozzles have a counter roller that guides the substrate thanks to the drying air that pushes the substrate against the roller. The flotation nozzles are made of two nozzles facing each other and blowing with the same strength against the substrate that “floats” between them. The front nozzle air is used for drying, the back nozzle air is used for heating and for avoiding the substrate from getting unbalanced. The drying unit starts with an impingement nozzle that regulates the speed of the air to avoid the fresh ink from getting spread on the substrate. The flotation nozzles and the following impingement nozzles regulate the volume of blown air to set the drying capabilities of the drying unit.

The invention relates to a drying unit for drying a substrate, especially of a drying unit of an inkjet printing machine.

Inkjet printing machines are typically applied for printing various products, such as labels, textiles, ceramic tiles and many more by dispensing small ink droplets through inkjet nozzles of a printing unit on the respective substrate to be printed upon.

A critical parameter for the efficiency of an inkjet printing machine is the maximum speed at which the substrate can be moved through the inkjet printing machine while ensuring a sufficient printing quality. The maximum speed is typically limited by the rate of drying of the ink after being applied on the substrate, as the freshly printed substrate must be handled with care to avoid mechanical contact with the applied ink as long as it has not been sufficiently dried. This effect is especially pronounced when using water-based inks instead of inks on the basis of organic solvents.

One option for accelerating the drying process is the use of drying units comprising nozzles which apply a stream of air onto the substrate, especially of heated air. However, the distance between the printed-upon substrate and such nozzles of the drying unit must be precisely controlled to avoid mechanical contact between the still wet substrate and the nozzles and to be able to provide the desired flow of air. Also, there is a risk that the applied air spreads the still wet ink onto the substrate, thereby reducing the overall printing quality.

The object of the invention is to provide a solution on how to efficiently dry a substrate onto which ink has been applied.

The object is solved by a drying unit for drying a substrate which is moved along a handling path through the drying unit, the substrate having a front side at least partially covered with fresh ink and a back side not covered with fresh ink. The drying unit comprises, along the handling path, two or more impingement nozzle units and one or more flotation nozzle units, the flotation nozzle units having a first flotation nozzle and an associated second flotation nozzle facing each other, and each of the impingement nozzle units having an impingement nozzle and an associated counter roller facing each other. The impingement nozzle of one or more of the impingement nozzle units is a speed-regulated impingement nozzle and the impingement nozzle of one or more of the impingement nozzle units is a volume-regulated impingement nozzle. The handling path is arranged between the impingement nozzle and the associated counter roller of the two or more impingement nozzle units and between the first flotation nozzle and the associated second flotation nozzle of the one or more flotation nozzle units. The drying unit is adapted to move the substrate through the drying unit such that the back side of the substrate is in contact with the counter roller of the two or more impingement nozzle units.

The invention is based on the idea to combine two different types of nozzle units, i.e. impingement nozzle units and flotation nozzle units, wherein the used impingement nozzle units are also of two different kinds, i.e. there is at least one speed-regulated impingement nozzle and at least one volume-regulated impingement nozzle.

The one or more impingement nozzle units provide a precise control on the relative position of the substrate along the handling path, i.e. of the substrate-to-nozzle-distance, by keeping the back side of the substrate in contact with the respective counter rollers of the one or more impingement nozzle units. The counter rollers also provide a means for moving the substrate along the handling path. At the same time, the associated impingement nozzle provides an air stream on the front side of the substrate, thereby contributing to the drying efficiency of the drying unit.

Further, the two different types of impingement nozzles allow to precisely tune the way in which air is supplied onto the front side of the substrate. In this way, an optimal compromise can easily be set between drying efficiency and avoiding ink spreading due to the interaction of the air applied by the impingement nozzle and the still at least partially wet ink on the substrate. Generally, a speed-regulated impingement nozzle will have a lower drying efficiency but also has a lower risk of spreading wet ink on the front side of the substrate. On the contrary, a volume-regulated impingement nozzle will have a higher drying efficiency but also has a higher risk of spreading wet ink on the front side of the substrate.

The one or more flotation nozzle units provide an air stream on both the front side and the back side of the substrate, i.e. the first flotation nozzle faces the front side of the substrate for drying the ink applied thereon and the second flotation nozzle provides an air stream on the back side of the substrate such that the substrate floats along the handling path. The flotation nozzle units generally provide a higher drying efficiency than the impingement nozzle units but provide a less stable arrangement of the substrate within the handling path, as there is no physical contact between a component of the flotation nozzle unit and the back side of the substrate.

The drying unit according to the invention especially is a drying unit of an inkjet printing machine.

In one variant, the drying unit comprises a first forward air chamber being fluidically connected to each of the impingement nozzles and each of the first flotation nozzles. In other words, each of the impingement nozzles and of the first flotation nozzles can be supplied with air for drying the ink on the substrate from a common first forward air chamber. Due to this arrangement, each of the impingement nozzles and of the first flotation nozzles can be supplied with air from a single air source. Further, the pressure drop at the nozzles of the drying unit connected to the first forward air chamber along the handling direction is negligible.

Also, the drying unit may comprise a second forward air chamber being fluidically connected to each of the second flotation nozzles. The two forward air chambers being either fluidically connected (thus can be considered as a single air chamber) or separate but connected to a common air source. Similar to the first forward air chamber discussed before, this arrangement allows to supply all of the second flotation nozzles from a single air source and the pressure drop at the nozzles of the drying unit connected to the backward air chamber is negligible.

The chamber crossed by the substrate constitutes a backward air chamber connected to a return path toward an air sink of an air supply device. The air control supply device comprises an air source with a number of outputs connected to the forward air chambers and a number of air sinks connected to the backward air chambers.

The volume-regulated impingement nozzle can comprise a nozzle opening facing the handling path, the size of the nozzle opening being variable. Thus, by adjusting the size of the nozzle opening, the volume of air which can be supplied by the volume-regulated impingement nozzle per time unit can be toggled. Especially in case the volume-regulated impingement nozzle is supplied with air from a constant pressure air source, e.g. via the first forward air chamber, the air speed stays constant when changing the size of the nozzle opening, while the air volume released per time unit is changed.

The speed-regulated impingement nozzle can comprise a nozzle opening facing the handling path, the size of the nozzle opening being variable, and can further comprise a membrane having a membrane opening, the membrane opening being of fixed size. Thus, especially in case the speed-regulated impingement nozzle is supplied with air from a constant pressure air source, e.g. via the first forward air chamber, the membrane opening of fixed size defines the flux of air traversing the membrane and thus being able to be released via the nozzle opening. Therefore, when the size of the nozzle opening is changed, the air speed is also changed while the overall air volume released per time unit stays constant.

The size of the impingement nozzle opening is preferably settable on each nozzle. In other words, there may be a mechanism capable of changing the size of the opening of the nozzle. Nevertheless, the nozzle opening may be set by design, thus using impingement nozzles with a fixed size opening. In the latter case, the openings should be set such that the speed of air at the output of the speed-regulated impingement nozzle be lower than the speed at the output of the volume-regulated impingement nozzle. When the speed/volume settings need to be changed, the impingement nozzles are replaced by nozzles with different opening sizes and/or with different membrane opening sizes. Thus, the speed or volume control at the nozzle output is performed by the selection of the opening of the nozzle among a set of available impingement nozzles.

For further reducing the risk of spreading the ink on the front side of the substrate due to the air supplied for drying, the first impingement nozzle of the drying unit, along the handling path, has a speed-regulated impingement nozzle. Thus, as the first impingement nozzle is a speed-regulated impingement nozzle, the speed of air supplied by said nozzle can be reduced such that no spreading of ink occurs or at least spreading of ink can be minimized.

The one or more impingement nozzle units following the first impingement nozzle unit, counted along the handling direction, e.g. the second impingement nozzle unit, can have a volume-regulated impingement nozzle. Therefore, the second impingement nozzle can be a volume-regulated impingement nozzle with a higher drying efficiency as the ink has already been at least partially dried when reaching the second impingement nozzle.

If the drying module has three or more impingement nozzle units, the second and higher impingement nozzle units, counted along the handling path, can have a volume-regulated impingement nozzle, while the first impingement nozzle unit can have a speed-regulated impingement nozzle.

For controlling the air flow through the one or more of the flotation nozzle units, each of the first flotation nozzle and the second flotation nozzle of the respective flotation nozzle unit can have a nozzle housing and a central element being configured to be movable relative to the nozzle housing along an adjustment direction which is perpendicular to the handling direction, the nozzle housing and the central element defining a flotation air path.

The flotation air path can have a first section being parallel to the adjustment direction and a second section arranged at an angle relative to the adjustment direction.

Preferably, the first section is of constant size while the size of the second section is variable based on the position of the central element. In this way, the air flow, i.e. the amount of air per time unit, through the respective flotation nozzle remains constant and thus the air speed of air released by the respective flotation nozzle is variable based on the position of the central element.

The central element can comprise an adjustment mechanism having an excentric being connected to a spring mechanism. Accordingly, the position of the central element along the adjustment direction can be controlled by means of the excentric. E.g., the excentric can be coupled to an actor like an electromotor. The spring mechanism is connected to the excentric to ensure the contact and remove the play between the excentric and the central element.

Further, the movements of the central elements of the first flotation nozzle and of the associated second flotation nozzle can be coupled. Termed differently, the motions of the central elements of associated first flotation nozzles and second flotation nozzles can be synchronized to avoid that the substrate is moved out of the handling path when adjusting only one of the respective central elements.

Preferably, the first flotation nozzle and the second flotation nozzle are configured such that the size of the movement of the central element of the first flotation nozzle is the same as the size of the movement of the central element of the second flotation nozzle.

In one variant, the drying unit has an alternating sequence of impingement nozzle units and flotation nozzle units along the handling direction, i.e. for each of the flotation nozzle units, along the handling path, an impingement nozzle unit is arranged directly before the flotation nozzle unit and an impingement nozzle unit is arranged directly after the flotation nozzle unit. Of course, in case the respective flotation nozzle unit is the first or the last nozzle unit of the sequence of impingement nozzle units and flotation nozzle units of the drying unit, there is no further impingement nozzle unit directly before and directly after the respective flotation nozzle unit, respectively. Such an arrangement allows for a good compromise between a high level of control of the substrate-to-nozzle distance (mainly obtained by the impingement nozzle units) and a high drying efficiency (as a flotation nozzle unit generally provides for a higher drying efficiency than an impingement nozzle unit).

For further minimizing the overall size of the inkjet printing machine, the handling path can comprise a forward path section and a backward path section, the forward path section and the backward path section being connected by a turnaround section. Thus, the backward path section therefore can be arranged geodetically above or below the forward path section.

The turnaround section preferably comprises a set of impingement and flotation nozzle units but may also be free of any impingement nozzle units and/or flotation nozzle units.

The drying unit can be adapted to move the substrate flipped upside down through the backward path section compared to the alignment of the substrate in the forward path section. This allows using a simpler design of the turnaround section of the drying unit, thereby reducing costs and space requirements. E.g., the front side of the substrate can face upwards in the forward path section and downwards in the backward path section, as the ink on the substrate has already at least partially dried when leaving the forward path section.

Preferably, all of the impingement nozzles in the backward path section are volume-regulated impingement nozzles. Accordingly, the drying efficiency of the impingement nozzles in the backward path section can be increased. As the ink on the substrate has already at least partially dried when reaching the backward path section, there is less risk of further spreading the ink by using volume-regulated impingement nozzles, thus allowing to make use exclusively of this type of impingement nozzles.

In one variant, the number and/or the sequence of the type of nozzle units are the same in the forward path section and the backward path section. Termed differently, the number and/or sequence of impingement nozzles and flotation nozzles are the same in these sections.

Preferably, the number and/or sequence of the type of nozzle units in the forward path section and the backward path section are symmetric except for the specific type of impingement nozzle used, i.e. in evaluating the symmetry it can be ignored whether speed-regulated impingement nozzles or volume-regulated impingement nozzle are used.

The drying unit can have a control unit being configured for controlling the air flow through the impingement nozzle units and the flotation nozzle units. The control unit especially is configured to adapt the size of any nozzle opening and/or the movement of any central element of the drying unit.

The object of the invention is further solved by the use of a drying unit as described before in an inkjet printing machine.

Further features and properties of the invention will become apparent from the following detailed description of preferred embodiments, which are not to be understood in a limiting manner, and from the Figures.

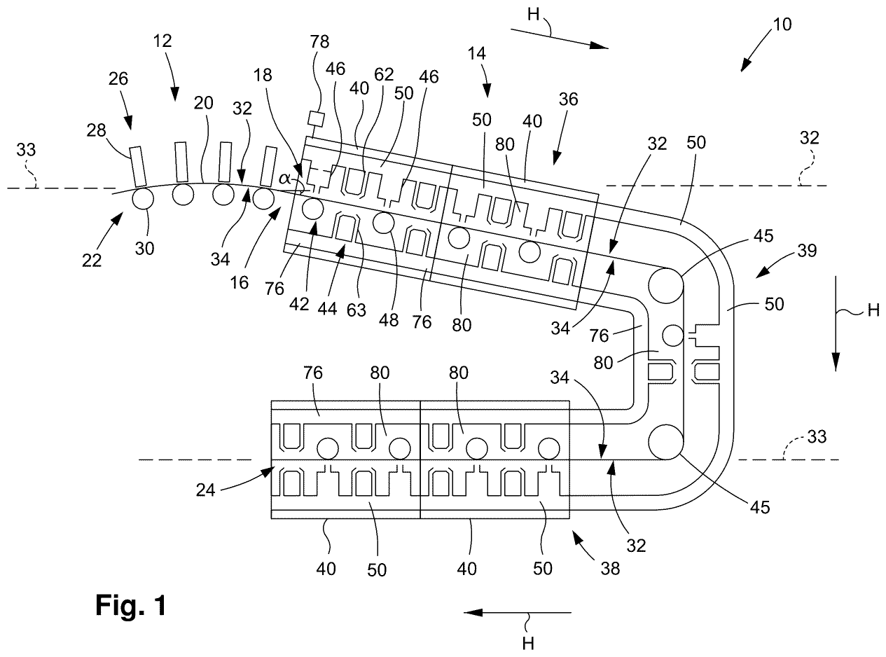

FIG. 1 schematically shows an inkjet printing machine comprising a drying unit according to the invention,

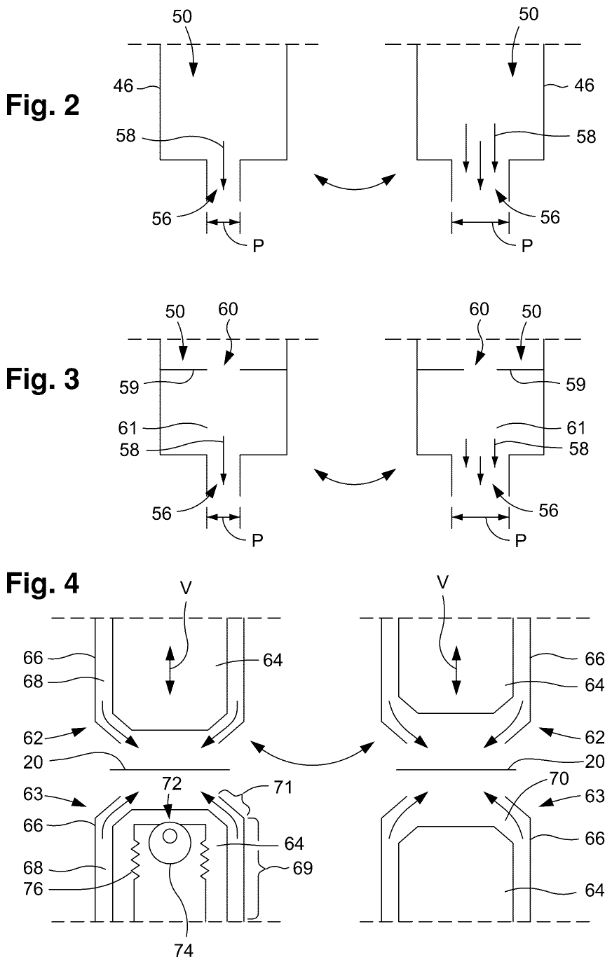

FIG. 2 shows a volume-regulated impingement nozzle used in the drying unit of FIG. 1,

FIG. 3 shows a speed-regulated impingement nozzle used in the drying unit of FIG. 1, and

FIG. 4 shows selected parts of a flotation nozzle unit of drying unit of FIG. 1.

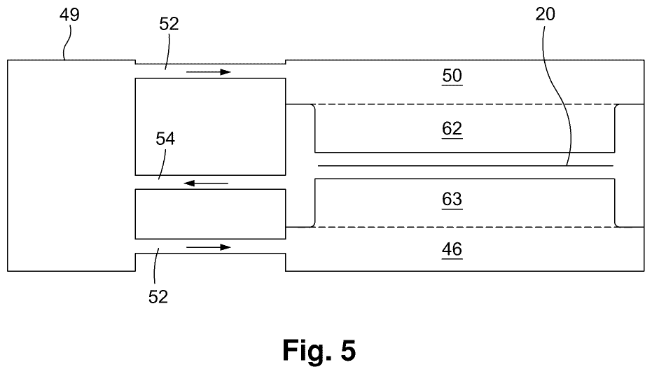

FIG. 5 shows a cross section of a drying module according to the invention and the connections of the air chambers to the air supply.

FIG. 1 schematically shows an inkjet printing machine 10 comprising a printing unit 12 and a drying unit 14 according to the invention, wherein only parts of the inkjet printing machine 10 which are necessary for understanding the invention have been depicted to simplify the Figure.

The printing unit 12 and the drying unit 14 are connected to each other, wherein a printing output 16 of the printing unit 12 is directly adjacent to a drying input 18 of the drying unit 14.

The inkjet printing machine 10 is used for manufacturing a printed product by applying ink onto a substrate 20 in the printing unit 12 followed by a drying process of the applied ink in the drying unit 14. The substrate 20 is supplied to the printing unit 12 e.g. from a (not shown) substrate delivery unit of the inkjet printing machine 10.

The substrate 20 is e.g. made out of paper or cardboard. However, in principle any substrate 20 can be used which can be printed upon by inkjet printing.

Within the printing unit 12, the substrate 20 is moved along a printing handling path which extends from a printing input 22 of the printing unit 12 to the printing output 16 of the printing unit 12.

Within the drying unit 14, the substrate 20 is moved along a drying handling path, also termed “handling path”, which extends from the drying input 18 to a drying output 24 of the drying unit 14.

The drying unit 14 comprises a forward path section 36, a backward path section 38 and a turnaround section 39 connecting the forward path section 36 and the backward path section 38.

Each of the forward path section 36 and the backward path section 38 comprises two drying modules 40, wherein each drying module 40 has two impingement nozzle units 42 and two flotation nozzle units 44 which will be explained later in greater detail.

Of course, the exact number of drying modules 40 as well as impingement nozzle units 42 and flotation nozzle units 44 can differ from the one shown in the exemplary embodiment of FIG. 1. Also, the number of drying modules 40 can differ between the forward path section 36 and the backward path section 38.

However, according to the invention, the drying unit 14 comprises at least two impingement nozzle units 42 and one flotation nozzle unit 44.

In the turnaround section 39, two turnaround rollers 45 are used for reversing the effective direction the substrate 20 is moved along. Termed differently, the substrate 20 is flipped upside down in the turnaround section 39. As shown in FIG. 1, the front side 32 of the substrate 20 is pointing upwards when leaving the forward path section 36 and is pointing downwards when entering the backward path section 38.

Accordingly, in the shown embodiment, the backward path section 38 is arranged geodetically below the forward path section 36.

Further, the backward path section 38 is arranged horizontally such that the backward path section 38 is parallel to the plane 33 which in turn is parallel to the ground on which the inkjet printing machine 10 is placed.

The forward path section 36 is arranged at an angle α relative to the horizontal direction, to be aligned with the output of the printing unit. The alignment is necessary to avoid touching the top of the substrate covered with fresh ink.

In the following, the different types of nozzles which are used in the drying unit 14 will be explained in more detail.

The impingement nozzle units 42 each comprise an impingement nozzle 46 and a counter roller 48 associated to the respective impingement nozzle 46.

The counter roller 48 acts as support for the substrate 20 and for moving the substrate 20 along the handling path. Accordingly, the back side 34 of the substrate 20 is in contact with the counter roller 48 such that the distance between the front side 32 and the impingement nozzle 46 is precisely controlled.

The impingement nozzle 46 is used to apply a stream of air onto the front side 32 of the substrate 20 for drying the ink, especially of heated air. The air is supplied to the impingement nozzle 46 by means of a first forward air chamber 50 which is fluidically connected with the impingement nozzle 46.

The first forward air chamber 50 is supplied with air via a forward air input 52 to which air is provided by an air supply module 49. The second forward air chamber 76 may also connected to the air supply module 49 by a forward air input 52, which may be provided with the same air. Alternatively, the second air chamber may be fluidically connected to the first forward air chamber 50 by a connection internal to the drying unit to form a common air chamber 50,76 connected to all the air nozzles of the drying unit. The backward air chamber is connected to the air supply module by a backward air sink 54.

FIG. 2 shows one type of impingement nozzle 46 which is a so-called “volume-regulated” impingement nozzle.

The volume-regulated impingement nozzle has a nozzle opening 56 facing the substrate 20 (see FIG. 1). The size of the nozzle opening 56 can be varied, as indicated by the arrows P in FIG. 2. Accordingly, the left depiction in FIG. 2 shows the nozzle opening 56 in a restricted state and the right depiction in FIG. 2 shows the nozzle opening 56 in an unrestricted state.

In the restricted state, the volume of air (indicated by arrows 58) being released by the nozzle opening 56 per time unit will be less than in the unrestricted state, given that the air pressure within the first forward air chamber 50 stays constant.

FIG. 3 shows another type of impingement nozzle 46 which is a so-called “speed-regulated” impingement nozzle.

The speed-regulated impingement nozzle also has a variable nozzle opening 56 analog to the volume-regulated impingement nozzle discussed before.

Additionally, the speed-regulated impingement nozzle comprises a membrane 59 having a membrane opening 60 of fixed size. The membrane 59 is arranged between the first forward air chamber 50 (see FIG. 1) and the nozzle opening 56, thereby defining a subsection 61 within the speed-regulated impingement nozzle. The volume of air which can flow into the subsection 61 per time unit is limited by the size of the membrane opening 60. Thus, when the state of the nozzle opening 56 is changed, instead of the total volume of air per time unit being changed, the speed of air being released by the nozzle opening 56 is varied.

To summarise, in a first-order approximation, a speed-regulated impingement nozzle provides a constant volume of air in a given time but delivers it at variable speed. On the contrary, a volume-regulated impingement nozzle delivers, in a first-order approximation, a variable amount (volume) of air in a given time but delivers it at a constant speed.

Which type of impingement nozzle 46 is used at which position within the drying unit 14 can be chosen according to the requirements of the desired drying procedure. However, according to the invention at least one of the impingement nozzle units 42 has a speed-regulated impingement nozzle and at least one of the impingement nozzle units 42 has a volume-regulated impingement nozzle.

Preferably, the speed of air released by the impingement nozzle 46 of the impingement nozzle unit 42 being arranged closest to the drying input 18 of the drying unit 14 is the lowest of all impingement nozzles 46 of the drying unit 14. In this way, the spreading of ink on the front side 32 of the substrate 20 can be minimized as at this position along the handling path the ink is still very wet as no drying procedure has been applied, yet. Thus, said impingement nozzle 46 is preferably a speed-regulated impingement nozzle.

One skilled in the art will appreciate that the types and relative arrangements of impingement nozzles 46 in the drying modules 40 and generally in the forward path section 36 and the backward path section 38 section can differ.

However, in a preferred embodiment, the number and/or the sequence of the type of nozzle units are the same in the forward path section 36 and the backward path section 38, with the only difference that in the backward path section 38 no speed-regulated impingement nozzle is used.

In the shown embodiment, along the handling path, between each two adjacent impingement nozzle units 42, a flotation nozzle unit 44 is arranged.

Each flotation nozzle unit 44 comprises a first flotation nozzle 62 and an associated second flotation nozzle 63 facing the first flotation nozzle 62.

As becomes clear from the depiction in FIG. 1, the first flotation nozzles 62 are facing the front side 32 of the substrate 20 while the second flotation nozzles 63 are facing the back side 34 of the substrate 20. Accordingly, the first flotation nozzles 62 are mainly responsible for drying the ink on the substrate 20 by applying air, while the second flotation nozzles 63 are used to heat the back of the substrate—which also contributes to drying—and are also used to balance the mechanical constraints that the air from the first flotation nozzles 62 apply on the substrate.

The flotation nozzles 62 and 63 are shown in more detail in FIG. 4.

As can be seen from FIG. 4, both the first flotation nozzle 62 and second flotation nozzle 63 have a central element 64 whose vertical position relative to the substrate 20 is variable along an adjustment direction as indicated by arrow V.

Between the central element 64 and a nozzle housing 66 of the respective flotation nozzle, a flotation air path 68 is defined having a first section 69 being parallel to the adjustment direction and a second section 71 being arranged at an angle relative to the adjustment direction, thereby defining a tilted chamber 70

whose size is dependent on the position of the central element 64 as indicated by double arrows in FIG. 4.

As the volume of the flotation air path 68 is constant until the tilted chamber 70 is reached, by varying the vertical position of the central element 64, the speed of air released by the respective flotation nozzle can be controlled based on the position of the central element 64.

The movements of the central elements 64 of the associated first flotation nozzle 62 and second flotation nozzle 63 are preferably synchronized to ensure that the position of the substrate 20 relative to each of the flotation nozzles 62 and 64 remains constant.

The movement of the central element 64 is realized by an adjustment mechanism 72 comprising an excentric 74 and a spring element 76 which ensures the contact between the excentric and the central element 64.

The inkjet printing machine 10 comprises a control unit 78 for controlling the movable parts of the impingement nozzles 46, the first flotation nozzles 62 and the second flotation nozzles 63.

The use of the drying unit 14 according to the invention in the inkjet printing machine 10 allows to provide an efficient and optimized drying procedure of the ink applied onto the substrate 20. Thus, high printing qualities and/or high maximum printing speeds can be reached and obtained, respectively.

1. A drying unit for drying a substrate which is moved along a handling path through the drying unit, the substrate having a front side at least partially covered with fresh ink and a back side not covered with fresh ink,
the drying unit comprising, along the handling path, two or more impingement nozzle units and one or more flotation nozzle units, the flotation nozzle units having a first flotation nozzle and an associated second flotation nozzle facing each other, and each of the impingement nozzle units having an impingement nozzle and an associated counter roller facing each other,
wherein the impingement nozzle of one or more of the impingement nozzle units is a speed-regulated impingement nozzle and the impingement nozzle of one or more of the impingement nozzle units is a volume-regulated impingement nozzle,
with the handling path being arranged between the impingement nozzle and the associated counter roller of the two or more impingement nozzle units and between the first flotation nozzle and the associated second flotation nozzle of the one or more flotation nozzle units, and
wherein the drying unit is adapted to move the substrate through the drying unit such that the back side of the substrate is in contact with the counter roller of the two or more impingement nozzle units.

2. The drying unit according to claim 1, the drying unit comprising a first forward air chamber being fluidically connected to each of the impingement nozzles and each of the first flotation nozzles.

3. The drying unit according to claim 2, the drying unit comprising a second forward air chamber being fluidically connected to each of the second flotation nozzles.

4. The drying unit according to claim 3, wherein the second forward air chamber is fluidically connected to the first forward air chamber to form a single forward air chamber.

5. The drying unit according to claim 1, wherein volume-regulated impingement nozzle comprises a nozzle opening facing the handling path, the size of the nozzle opening being variable.

6. The drying unit according to claim 1, wherein the speed-regulated impingement nozzle comprises a nozzle opening facing the handling path, the size of the nozzle opening being variable, and further comprises a membrane having a membrane opening the membrane opening being of fixed size.

7. The drying unit according to claim 1, wherein, along the handling path, the first impingement nozzle unit having a speed-regulated impingement nozzle.

8. The drying unit according to claim 1, the first flotation nozzle and the second flotation nozzle each having a nozzle housing and a central element being configured to be movable relative to the nozzle housing along an adjustment direction which is perpendicular to the handling direction, the nozzle housing and the central element defining a flotation air path.

9. The drying unit according to claim 8, the flotation air path having a first section being parallel to the adjustment direction and a second section arranged at an angle relative to the adjustment direction.

10. The drying unit according to claim 1, the drying unit having an alternating sequence of impingement nozzle units and flotation nozzle units along the handling direction.

11. The drying unit according to claim 1, the handling path comprising a forward path section and a backward path section the forward path section and the backward path section being connected by a turnaround section.

12. The drying unit according to claim 11, wherein the drying unit is adapted to move the substrate flipped upside down through the backward path section compared to the alignment of the substrate in the forward path section.

13. The drying unit according to claim 11, wherein all of the impingement nozzles in the backward path section are volume-regulated impingement nozzles.

14. The drying unit according to claim 11, wherein the number and/or the sequence of the type of nozzle units are the same in the forward path section and the backward path section.

15. The drying unit according to claim 1, the drying unit having a control unit being configured for controlling the air flow through the impingement nozzle units and the flotation nozzle units.
